(19) United States
(12) Patent Application Publication
(10) Pub. No.: US 2018/0297581 A1
(43) Pub. Date: Oct. 18, 2018

(54) GEAR SHIFT SCHEDULING USING VARIABLE VALVE LIFT/ACTUATION

(71) Applicants: Amit Shrestha, Rochester Hills, MI (US); Fadi Estefanous, Warren, MI (US); Lurun Zhong, Troy, MI (US)

(72) Inventors: Amit Shrestha, Rochester Hills, MI (US); Fadi Estefanous, Warren, MI (US); Lurun Zhong, Troy, MI (US)

(21) Appl. No.: 15/486,542

(22) Filed: Apr. 13, 2017

(51) Int. Cl. B60W 20/15; B60W 10/06; B60W 10/08; B60W 10/11; B60W 30/19

(52) U.S. Cl. CPC B60W 20/15; B60W 10/06; B60W 10/08; B60W 10/11; B60W 30/19; B60W 2510/0638; Y10S 903/93; B60W 2710/0666; B60W 2710/083; B60W 2710/0633; B60W 2710/1005; B60Y 2200/92; B60W 2520/10

(57) ABSTRACT

A vehicle powertrain control technique includes obtaining, by a controller, a set of parameters each indicative of a gear shift operation for an automatic transmission. Cased on the set of parameters, the controller detects whether a gear shift operation of the automatic transmission is imminent. In response to detecting that the gear shift operation of the automatic transmission is imminent, the controller (i) determines a desired reduction in powertrain output torque for performing the gear shift operation and (ii) controls the powertrain to temporarily reduce its torque output via a technique other than spark retardation. After reducing the powertrain output torque, the controller commands the automatic transmission to perform the gear shift operation. The temporary powertrain output torque reduction is achieved by controlling a variable valve control (VVC) system of an engine, such as commanding a lower valve lift profile, or decreasing power supplied to an electric motor.

### FIELD

The present application relates to gear shift scheduling techniques using variable valve lift (VVL) or variable valve actuation (VVA) systems.

### BACKGROUND

An internal combustion engine generates drive torque at a crankshaft and a transmission transfers the drive torque from the crankshaft to a drivetrain (e.g., wheels) of a vehicle. For automatic transmissions, a vehicle control system (e.g., a controller) schedules and executes gear shift operations. One primary goal of vehicle control systems is to perform gear shift operations that are not noticeable to the driver. That is, any noise/vibration/harshness (NVH) or “clunk” caused by the gear shift operations should be avoided or mitigated. In order to perform smoother gear shift operations, engine torque must be temporarily reduced.

Conventional vehicle control systems utilize spark retardation to temporarily reduce engine torque to perform smoother shift operations. Spark retardation, however, increases exhaust gas temperature (e.g., to approximately 1200 degrees Celsius). These high exhaust gas temperatures negatively affect the life of the vehicle's catalytic converter, brake-specific carbon monoxide (BSCO) or similar emissions (e.g., HC slip), and/or fuel economy. Accordingly, while such vehicle control systems work well for their intended purpose, there remains a need for improvement in the relevant art.

### SUMMARY

According to one example aspect of the invention, a control system for a vehicle having a powertrain comprising an automatic transmission is presented. In one exemplary implementation, the system comprises a set of sensors configured to measure a set of parameters each indicative of a gear shift operation for the automatic transmission and a controller configured to: based on the measured set of parameters, detect whether a gear shift operation of the automatic transmission is imminent; in response to detecting that the gear shift operation of the automatic transmission is imminent: (i) determine a desired reduction in powertrain output torque for performing the gear shift operation and (ii) controlling the powertrain to temporarily reduce its torque output by controlling at least one of (a) a variable valve control (VVC) system of an engine of the powertrain and (b) an electric motor of the powertrain; and after reducing the powertrain output torque, command the automatic transmission to perform the gear shift operation.

In some implementations, the VVC system is configured to control at least one of a lift of and an actuation of an intake valve of the engine. In some implementations, the VVC system is configured to temporarily decrease the lift of the intake valve to a first desired lift corresponding to the desired reduction in powertrain output torque. In some implementations, the controller is further configured to, after performing the gear shift operation, command the VVC system to increase the lift of the intake valve to a second desired lift corresponding to optimal engine performance.

In some implementations, the controlling of the VVC system to temporarily reduce powertrain output torque causes a smaller change in exhaust gas temperature compared to spark retardation for temporary powertrain torque reduction. In some implementations, the smaller change in exhaust gas temperature increases a life of a catalytic converter of the vehicle compared to spark retardation. In some implementations, the smaller change in exhaust gas temperature decreases engine emissions compared to spark retardation. In some implementations, the controlling of the VVC system to temporarily reduce powertrain output torque causes an increase in engine fuel economy compared to spark retardation.

In some implementations, the controller is configured to control a power supplied to the electric motor to temporarily reduce the powertrain torque output. In some implementations, the set of measured parameters includes at least one of engine load, engine speed, and vehicle speed.

According to another example aspect of the invention, a method for controlling a powertrain of a vehicle is presented. In one exemplary implementation, the method comprises obtaining, by a controller, a set of parameters each indicative of a gear shift operation for an automatic transmission of the powertrain; based on the set of parameters, detecting, by the controller, whether a gear shift operation of the automatic transmission is imminent; in response to detecting that the gear shift operation of the automatic transmission is imminent: (i) determining, by the controller, a desired reduction in powertrain output torque for performing the gear shift operation and (ii) controlling, by the controller, the powertrain to temporarily reduce its torque output by controlling at least one of (a) a variable valve control (VVC) system of an engine of the powertrain and (b) an electric motor of the powertrain; and after reducing the powertrain output torque, commanding, by the controller, the automatic transmission to perform the gear shift operation.

In some implementations, the VVC system is configured to control at least one of a lift of and an actuation of an intake valve of the engine. In some implementations, the VVC system is configured to temporarily decrease the lift of the intake valve to a first desired lift corresponding to the desired reduction in powertrain output torque. In some implementations, the method further comprises after performing the gear shift operation, commanding, by the controller, the VVC system to increase the lift of the intake valve to a second desired lift corresponding to optimal engine performance.

In some implementations, the controlling of the VVC system to temporarily reduce powertrain output torque causes a smaller change in exhaust gas temperature compared to spark retardation for temporary powertrain torque reduction. In some implementations, the smaller change in exhaust gas temperature increases a life of a catalytic converter of the vehicle compared to spark retardation. In some implementations, the smaller change in exhaust gas temperature decreases engine emissions compared to spark retardation. In some implementations, the controlling of the VVC system to temporarily reduce powertrain output torque causes an increase in engine fuel economy compared to spark retardation.

In some implementations, controlling the powertrain comprises controlling a power supplied to the electric motor to temporarily reduce the powertrain torque output. In some implementations, the set of measured parameters includes at least one of engine load, engine speed, and vehicle speed.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example vehicle having a powertrain comprising an automatic transmission according to some aspects of the present disclosure;

FIG. 2 is a flow diagram of an example method of gear shift scheduling according to some aspects of the present disclosure;

FIGS. 3A-3B are flow diagrams of example methods of temporarily reducing powertrain output torque in the example method of FIG. 2; and

FIGS. 4A-4D are plots of engine torque, spark timing, exhaust temperature, engine emissions, and valve lift for both conventional spark retardation-based gear shift control and VVC-based gear shift control according to some aspects of the present disclosure.

### DETAILED DESCRIPTION

As previously discussed, conventional transmission control systems perform spark retardation to temporarily reduce engine torque, at the cost of catalytic converter life, engine-out emissions (e.g., brake-specific carbon monoxide (CO), or BSCO), and/or fuel economy. Some engines include variable valve control (VVC) systems that control a lift, timing, and/or actuation of intake valves of the engine, which in turn control the flow of fresh air into the cylinders. In some implementations, Variable valve lift (VVL) systems control lift of the intake valves, whereas variable valve actuation (VVA) systems control actuation of the intake valves by a camshaft. Another type of VVC system is variable valve timing (VVT), which controls intake valve open/close timing. A VVL system, for example, may operate the intake valves according to two different cam profiles: a low-lift mode for low engine loads and a high-lift mode for high engine loads.

The techniques of the present disclosure utilize an engine's existing VVC system to temporarily reduce engine torque for gear shift operations, thereby eliminating or mitigating the negative effects (decreased catalytic converter lift, increased BSCO emissions, and/or decreased fuel economy, etc.) caused by spark retardation. More specifically, a lower-lift valve profile or a different camshaft profile is utilized to achieve the same level of engine torque that would be previously be achieved using spark retardation. This lower-lift valve profile or different camshaft profile induces only the required amount of air to fill the cylinder in order to produce this desired level of engine torque during the gear shift operation. This lesser air charge requires less fuel and the combustion of the smaller air/fuel charge results in a reduction in the torque generated by the engine.

In some implementations, this temporary reduction in output torque for smoother gear shift operations could be achieved by controlling a hybrid powertrain. More specifically, a hybrid vehicle (e.g., a plug-in hybrid electric vehicle, or PHEV) typically includes one or more electric motors and an optional engine. In these types of vehicles, one or more of the electric motors could be controlled to temporarily reduce powertrain output torque for the gear shift operation, without having to retard spark timing of an engine. This could include, for example, temporarily decreasing the power (e.g., current) supplied to the one or more electric motors, which in turn would temporarily decrease the powertrain output torque.

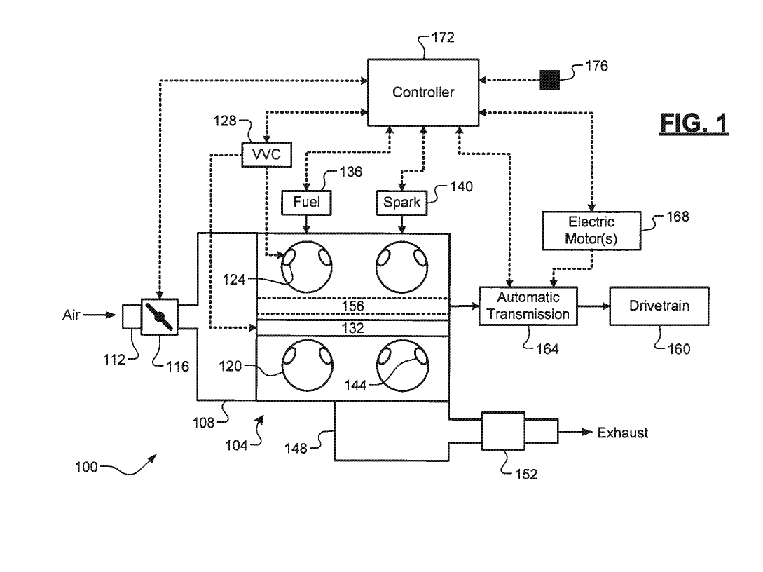

Referring now to FIG. 1, a diagram of an example vehicle 100 is illustrated. The vehicle 100 includes an engine 104 that is configured to combust a mixture of air and fuel (e.g., gasoline) to generate drive torque. The engine 104 could be any suitable type of spark-ignition engine. In operation, the engine 104 draws air into an intake manifold 108 through an induction system 112 that is selectively regulated by a throttle valve 116. The air in the intake manifold 108 is distributed to a plurality of cylinders 120 via respective intake valves 124. While four cylinders are shown, it will be appreciated that the engine 104 could include any suitable number of cylinders. The lift and/or actuation of the intake valves 124 is controlled by a VVC system 128. In some exemplary implementations, the VVC system 128 utilizes a hydraulic actuator to adjust a lift of the intake valves (e.g., VVL) or a solenoid to switch between two or more different profiles of a camshaft 132 (e.g., VVA). While a single camshaft 132 is shown, it will be appreciated that the engine 104 could include a plurality of different camshafts.

The air provided to the cylinders 120 is also combined with fuel from fuel injectors 136 to create an air/fuel mixture. The fuel injectors 136 are configurable in any suitable injection configuration (port fuel injection, direct fuel injection, etc.). The air/fuel mixture within the cylinders 120 is compressed by pistons (not shown) and the compressed air/fuel mixture is combusted by spark provided by spark plugs 140. Exhaust gas resulting from combustion is expelled from the cylinders 120 via respective exhaust valves 144 and into an exhaust treatment system 148. The exhaust treatment system 148 treats the exhaust gas to eliminate or reduce emissions before releasing it into the atmosphere. One example component of the exhaust treatment system 148 is a catalytic converter 152, such as a three-way catalytic converter (TWC) that is configured to convert CO, nitrogen oxide (NOx), and hydrocarbon (HC) to nitrogen, oxygen, carbon dioxide (CO₂), and water (H₂O)).

The combustion of the compressed air/fuel mixture drives the pistons (not shown), which rotatably turn a crankshaft 156 and generate drive torque. The drive torque is transferred from the crankshaft 156 to a drivetrain 160 (e.g., wheels) of the vehicle 100 via an automatic transmission 164. The automatic transmission 164 is configured to operate in a plurality of different gear ratios for varying the translation of the drive torque from the crankshaft 156 to the drivetrain 160. In some implementations, the vehicle 100 is a hybrid vehicle that includes one or more electric motors 168 that are configured to output drive torque, e.g., to the automatic transmission 164 to propel the vehicle 100 or to the crankshaft 156 to start the engine 104. Thus, for such hybrid vehicles, the engine 104 is optional. The engine 104, the electric motor(s) 168, and combinations thereof are collectively referred to as a torque generating system of a powertrain of the vehicle 100 (and the powertrain can further include the automatic transmission 164). The operation of the vehicle 100, including the control of the VVC system 128, the automatic transmission 164, and the optional electric motor(s) 168, is controlled by a controller 172. It will be appreciated that the controller 172 also controls other suitable components of the vehicle, such as the throttle valve 116, the fuel injectors 136, the spark plugs 140, and the exhaust valves 144. The controller 172 also receives a set of measured parameters from a set of sensors 176, respectively.

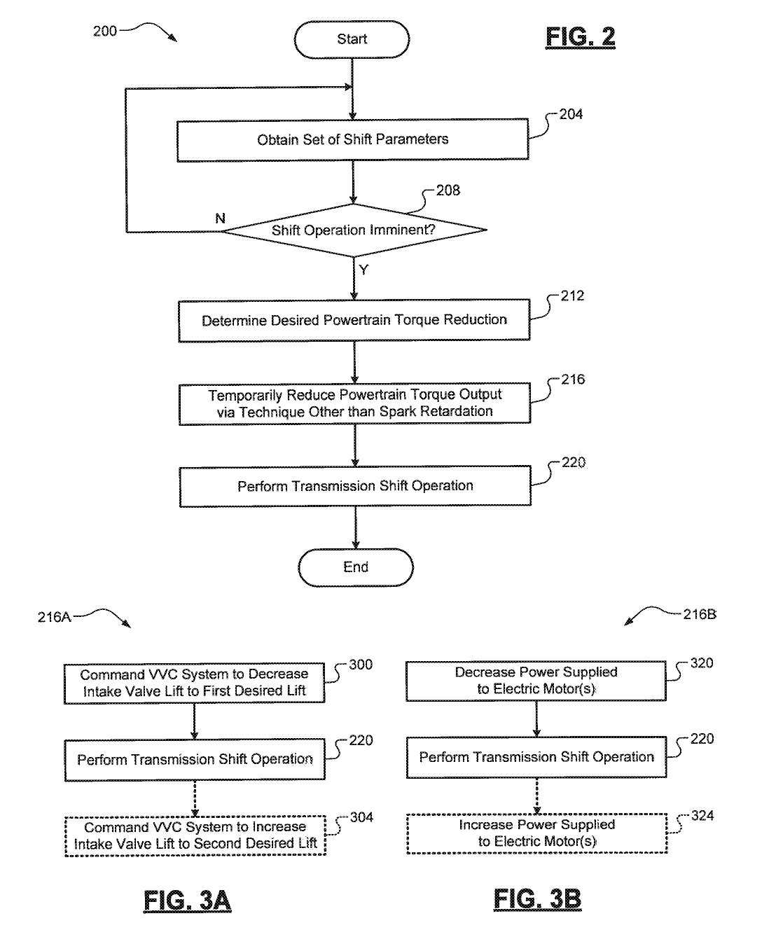

Referring now to FIG. 2, an example flow diagram of a method 200 of gear shift scheduling using torque reduction technique(s) other than spark retardation is illustrated. At 204, the controller 172 obtains a set of parameters indicative of a gear shift operation of the automatic transmission 164. These parameters, for example, could be measured by the set of sensors 172. At least some of the parameters, however, could be modeled, e.g., based on other measured parameter(s). Non-limiting examples of these parameters include engine load (e.g., accelerator pedal position), engine or crankshaft speed, and vehicle or drivetrain speed. Other suitable parameters could be modeled/measured and utilized, provided they are indicative of the need for a shift operation of the automatic transmission 164, e.g., to optimize vehicle performance.

At 208, the controller 172 detects whether the shift operation of the automatic transmission 164 is imminent. The term “imminent” as used herein refers to the shift operation being scheduled or needing to be performed within a certain period after the detecting. When the shift operation of the automatic transmission 164 is imminent, the method 200 proceeds to 212. Otherwise, the method 200 ends or returns to 204 or 208. At 212, the controller 172 determines a desired reduction in powertrain torque for performing the gear shift operation, e.g., using a lookup table. This desired reduction in powertrain output torque could be predetermined or modeled and stored in a lookup table. For example, different gear-to-gear shift operations could require different powertrain output torque reductions. Other factors could also affect the desired reduction in powertrain output torque, such as temperature, engine/vehicle speed, and the like.

At 216, the controller 172 temporarily reduces the powertrain torque via a technique other than spark retardation. In one exemplary implementation 216A, the controller 172 commands the VVC system 128 to decrease a lift profile of the intake valve 124 to a first desired lift (e.g., VVL) corresponding to a desired reduction in engine torque at 300. In such an implementation, this first desired lift of the intake valve 124 represents a lesser lift compared to a currently commanded lift, which may be optimized for vehicle performance (acceleration, fuel economy, etc.). This change in intake valve lift causes the desired reduction in engine torque. Instead of decreasing valve lift, the VVC system 128 could alternatively change a camshaft profile (e.g., VVA) to achieve a similar reduction in airflow into the cylinder 120 to achieve the same reduction in engine output torque.

After this occurs, the controller 172 performs the shift operation of the automatic transmission 164 at 220. In exemplary implementation 216A, the method 200 optionally further comprises the controller 172 commanding the VVC system 128 to return the lift of the intake valve 124 to its previous lift or to a different second desired lift that is optimized for vehicle performance at 304. The method 200 then ends or returns to 204 for one or more additional cycles. In another exemplary implementation 216B, the controller 172 temporarily reduces the powertrain output torque by decreasing power supplied to the electric motor(s) 168 at 320. This exemplary implementation 216B optionally further includes the controller 172 increasing the power supplied to the electric motor 168 to its previous power or a power level optimized for vehicle performance at 324.

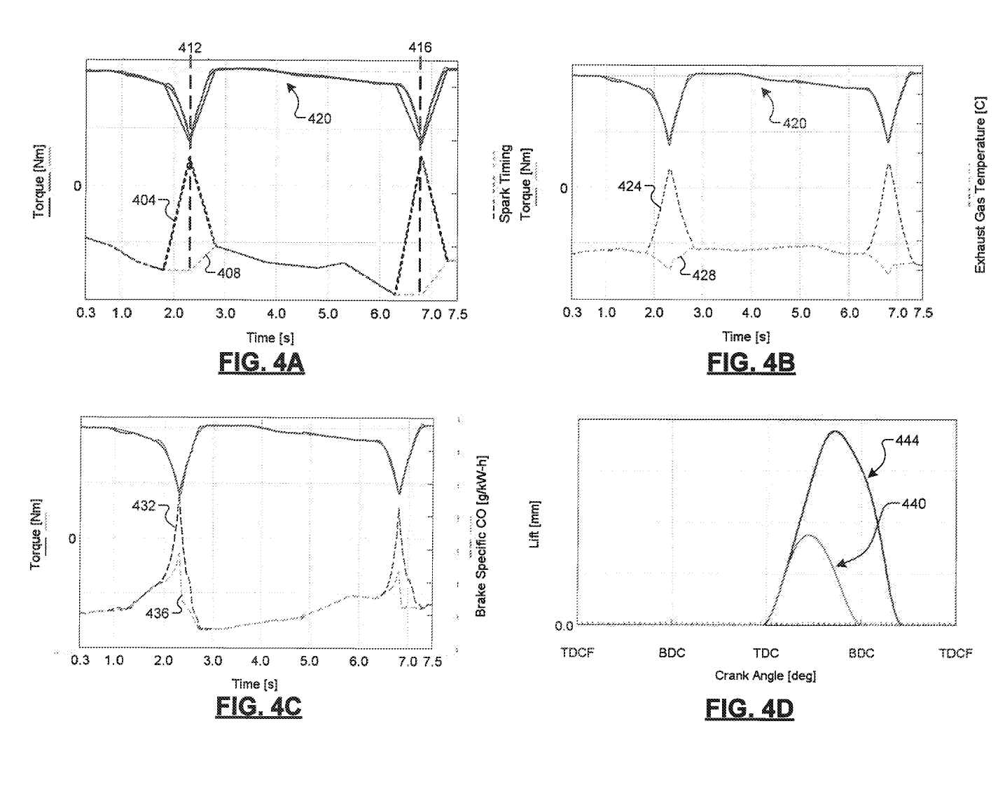

Referring now to FIGS. 4A-4D, example plots of engine torque, spark timing, exhaust temperature, engine emissions, and valve lift for both conventional spark retardation-based gear shift control and VVC-based gear shift control are illustrated. In FIG. 4A, conventional spark retardation is illustrated by line 404 and spark timing for the VVC-based gear shift control is illustrated by line 408. As shown, conventional spark retardation is commanded for a first gear shift 412 at about 1.8 seconds and a second gear shift 416 at about 6.3 seconds to temporarily reduce engine torque for two different gear shift operations. The corresponding reductions in engine torque are illustrated by lines 420. As shown, the disclosed techniques achieve approximately the same engine torque reduction without spark retardation.

In FIG. 4B, this conventional spark retardation causes an increase in exhaust gas temperature to greater than 1100 degrees Celsius as shown by line 424. Repeated exposure to such an extreme high temperature decreases the life of the catalytic converter 152. The disclosed techniques, on the other hand, maintain exhaust gas temperature below 900 degrees Celsius as shown by line 428. In FIG. 4C, BSCO emissions also increase as a result of this conventional spark retardation as shown by line 432. As shown, this increase is to greater than 500 grams per kilowatt hour (g/kW-h). Fuel enrichment may therefore be needed for cooling, which further decreases fuel economy. The disclosed techniques, on the other hand, maintain the BSCO emissions below 400 g/kW-h as shown by line 436.

As shown in FIG. 4D, the first desired lift 440 of the intake valve 124 is much less than the current or second desired lift 444 of the intake valve 124. As previously mentioned herein, this lift 444 could be optimized for vehicle performance. Using this first desired lift 440, engine torque is reduced by approximately the same amount as shown in FIG. 4A. Similarly, exhaust gas temperature is reduced by approximately 27% (see FIG. 4B) and BSCO is reduced by approximately 40%. This VVC-based gear shift scheduling technique and its corresponding benefits discussed above also result a reduction of fuel consumption during the gear shift operation of approximately 43% (e.g., a lesser air charge requires less fuel, plus no fuel enrichment for cooling is needed).

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for a vehicle having a powertrain including an automatic transmission, the control system comprising:
one or more sensors configured to measure a set of parameters each indicative of a gear shift operation for the automatic transmission; and
a controller configured to:
based on the measured set of parameters, detect whether a gear shift operation of the automatic transmission is imminent;
in response to detecting that the gear shift operation of the automatic transmission is imminent:
(i) determine a desired reduction in powertrain output torque for performing the gear shift operation, and
(ii) controlling the powertrain to temporarily reduce its torque output by controlling at least one of (a) a variable valve control (VVC) system of an engine of the powertrain and (b) an electric motor of the powertrain; and
after reducing the powertrain output torque, command the automatic transmission to perform the gear shift operation.

2. The control system of claim 1, wherein the VVC system is configured to control at least one of a lift of and an actuation of an intake valve of the engine.

3. The control system of claim 2, wherein the VVC system is configured to temporarily decrease the lift of the intake valve to a first desired lift corresponding to the desired reduction in powertrain output torque.

4. The control system of claim 3, wherein the controller is further configured to, after performing the gear shift operation, command the VVC system to increase the lift of the intake valve to a second desired lift corresponding to optimal engine performance.

5. The control system of claim 2, wherein the controlling of the VVC system to temporarily reduce powertrain output torque causes a smaller change in exhaust gas temperature compared to spark retardation for temporary powertrain torque reduction.

6. The control system of claim 5, wherein the smaller change in exhaust gas temperature increases a life of a catalytic converter of the vehicle compared to spark retardation.

7. The control system of claim 5, wherein the smaller change in exhaust gas temperature decreases engine emissions compared to spark retardation.

8. The control system of claim 2, wherein the controlling of the VVC system to temporarily reduce powertrain output torque causes an increase in engine fuel economy compared to spark retardation.

9. The control system of claim 1, wherein the controller is configured to control a power supplied to the electric motor to temporarily reduce the powertrain torque output.

10. The control system of claim 1, wherein the set of measured parameters includes at least one of engine load, engine speed, and vehicle speed.

11. A method for controlling a powertrain of a vehicle, the powertrain comprising an automatic transmission, the method comprising:
obtaining, by a controller, a set of parameters each indicative of a gear shift operation for the automatic transmission;
based on the set of parameters, detecting, by the controller, whether a gear shift operation of the automatic transmission is imminent;
in response to detecting that the gear shift operation of the automatic transmission is imminent:
(i) determining, by the controller, a desired reduction in powertrain output torque for performing the gear shift operation, and
(ii) controlling, by the controller, the powertrain to temporarily reduce its torque output by controlling at least one of (a) a variable valve control (VVC) system of an engine of the powertrain and (b) an electric motor of the powertrain; and
after reducing the powertrain output torque, commanding, by the controller, the automatic transmission to perform the gear shift operation.

12. The method of claim 11, wherein the VVC system is configured to control at least one of a lift of and an actuation of an intake valve of the engine.

13. The method of claim 12, wherein the VVC system is configured to temporarily decrease the lift of the intake valve to a first desired lift corresponding to the desired reduction in powertrain output torque.

14. The method of claim 13, further comprising after performing the gear shift operation, commanding, by the controller, the VVC system to increase the lift of the intake valve to a second desired lift corresponding to optimal engine performance.

15. The method of claim 12, wherein the controlling of the VVC system to temporarily reduce powertrain output torque causes a smaller change in exhaust gas temperature compared to spark retardation for temporary powertrain torque reduction.

16. The method of claim 15, wherein the smaller change in exhaust gas temperature increases a life of a catalytic converter of the vehicle compared to spark retardation.

17. The method of claim 15, wherein the smaller change in exhaust gas temperature decreases engine emissions compared to spark retardation.

18. The method of claim 12, wherein the controlling of the VVC system to temporarily reduce powertrain output torque causes an increase in engine fuel economy compared to spark retardation.

19. The method of claim 11, wherein controlling the electric motor comprises controlling a power supplied to the electric motor to temporarily reduce the powertrain torque output.

20. The method of claim 11, wherein the set of measured parameters includes at least one of engine load, engine speed, and vehicle speed.
